(19) United States
(12) Patent Application Publication
(10) Pub. No.: US 2020/0082279 A1
(43) Pub. Date: Mar. 12, 2020

(54) NEURAL NETWORK INFERENCING ON PROTECTED DATA

(71) Applicant: Synaptics Incorporated, San Jose, CA (US)

(72) Inventor: Gaurav Arora, Cupertino, CA (US)

(21) Appl. No.: 16/539,847

(22) Filed: Aug. 13, 2019

Related U.S. Application Data
(60) Provisional application No. 62/729,947, filed on Sep. 11, 2018.

(51) Int. Cl. G06N 5/04; G06N 3/063; G06N 3/04

(52) U.S. Cl. CPC G06N 5/04; G06N 3/0454; G06N 3/063

(57) ABSTRACT

A method and apparatus for inferencing on protected data. A user device retrieves protected data from a secure memory, generates inferences about the protected data using one or more neural network models stored on the user device, and updates a user interface of the user device based at least in part on the inferences. The secure memory is inaccessible to applications executing in a rich environment of the user device. Thus, in some aspects, the inferences may be generated, at least in part, by a neural network application executing in a trusted environment of the user device.

### CROSS-REFERENCE TO RELATED APPLICATION

This application claims priority and benefit under 35 USC § 119(e) to U.S. Provisional Patent Application No. 62/729,947, filed on Sep. 11, 2018, which is incorporated herein by reference in its entirety.

### TECHNICAL FIELD

The present embodiments relate generally to systems and devices for machine learning.

### BACKGROUND OF RELATED ART

Machine learning is a technique for improving the ability of a computer system or application to perform a certain task. Machine learning can be broken down into two component parts: training and inferencing. During the training phase, a machine learning system is provided with an “answer” and a large volume of raw data associated with the answer. For example, a machine learning system may be trained to recognize cats by providing the system with a large number of cat photos and/or videos (e.g., the raw data) and an indication that the provided media contains a “cat” (e.g., the answer). The machine learning system may then analyze the raw data to “learn” a set of rules that can be used to describe the answer. For example, the system may perform statistical analysis on the raw data to determine a common set of rules that can be associated with the term “cat” (e.g., whiskers, paws, fur, four legs, etc.). The set of rules may be referred to as a neural network model. During the inferencing phase, the machine learning system may apply the rules to new data to generate answers or inferences about the data. For example, the system may analyze a family photo and determine, based on the learned rules, that the photo includes an image of a cat.

### SUMMARY

This Summary is provided to introduce in a simplified form a selection of concepts that are further described below in the Detailed Description. This Summary is not intended to identify key features or essential features of the claims subject matter, nor is it intended to limit the scope of the claimed subject matter.

A method and apparatus for inferencing on protected data is disclosed. One innovative aspect of the subject matter of this disclosure can be implemented in a method of inferencing by a user device. In some embodiments, the method may include steps of retrieving protected data from a secure memory, where the secure memory is inaccessible to applications executing in a rich environment of the user device, generating inferences about the protected data using one or more neural network models stored on the user device, and updating a user interface of the user device based at least in part on the inferences.

Another innovative aspect of the subject matter of this disclosure can be implemented in a user device. The user device includes processing circuitry configured to operate in a secure state or a non-secure state and a memory having a secure partition and a non-secure partition. The secure partition stores instructions that, when executed by the processing circuitry while operating in the secure state, causes the user device to retrieve protected data from the secure partition, where the secure partition is inaccessible to the processing circuitry when operating in the non-secure state, retrieve one or more neural network models from the secure partition, and generate inferences about the protected data using the one or more neural network models.

### BRIEF DESCRIPTION OF THE DRAWINGS

The present embodiments are illustrated by way of example and are not intended to be limited by the figures of the accompanying drawings.

FIG. 1 shows a block diagram of a machine learning system, in accordance with some embodiments.

FIG. 2 shows a block diagram of a user device, in accordance with some embodiments.

FIG. 3 shows a sequence diagram depicting an example process for performing machine learning on protected data, in accordance with some embodiments.

FIG. 4 shows a block diagram of a processing system, in accordance with some embodiments.

FIG. 5 shows another block diagram of a user device, in accordance with some embodiments.

FIG. 6 is an illustrative flowchart depicting an operation for inferencing by a user device, in accordance with some embodiments.

FIG. 7 is an illustrative flowchart depicting an example image capture operation, in accordance with some embodiments.

FIG. 8 is an illustrative flowchart depicting an example media playback operation, in accordance with some embodiments.

FIG. 9 is an illustrative flowchart depicting an example authentication operation, in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein may refer to any general-purpose processor, conventional processor, controller, microcontroller, and/or state machine capable of executing scripts or instructions of one or more software programs stored in memory.

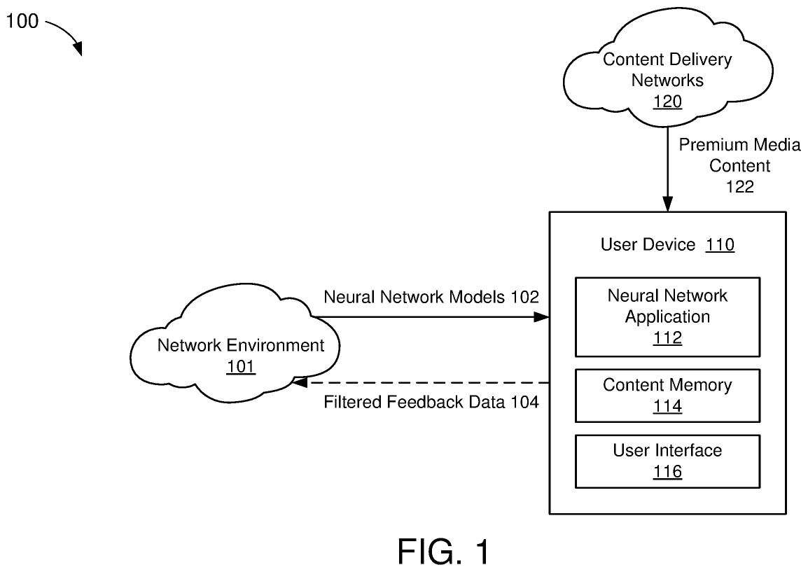

FIG. 1 shows a block diagram of a machine learning system 100, in accordance with some embodiments. The system 100 includes a network environment 101 and a user device 110. In some embodiments, the network environment 101 may communicate with the user device 110 to perform machine learning on private and/or protected content stored on, or otherwise accessible by, the user device 110.

The network environment 101 may be configured to generate one or more neural network models 102 through deep learning. Deep learning is a particular form of machine learning in which the training phase is performed over multiple layers, generating a more abstract set of rules in each successive layer. Deep learning architectures are often referred to as artificial neural networks due to the way in which information is processed (e.g., similar to a biological nervous system). For example, each layer of the deep learning architecture may be composed of a number of artificial neurons. The neurons may be interconnected across the various layers so that input data (e.g., the raw data) may be passed from one layer to another. More specifically, each layer of neurons may perform a different type of transformation on the input data that will ultimately result in a desired output (e.g., the answer). The interconnected framework of neurons may be referred to as a neural network model. Thus, the neural network models 102 may include a set of rules that can be used to describe a particular object or feature (such as a cat).

In some aspects, the network environment 101 is a cloud computing platform that may receive raw data from a plurality of sources (including the user device 110 and/or other content sources that communicate with network environment 101). The network environment 101 may be trained to recognize a set of rules (e.g., certain objects, features, a quality of service, such as a quality of a received signal or pixel data, and/or other detectable attributes) associated with the raw data. For example, in some aspects, the network environment 101 may be trained to recognize one or more logos (e.g., used in company branding and/or advertisements). During the training phase, the network environment 101 may receive a large number of photos and/or videos that contain such logos from one or more content sources communicatively coupled to the network environment 101. The network environment 101 may also receive an indication that the provided media contains a logo (e.g., in the form of user input from a user or operator reviewing the media and/or data or metadata provided with the media). The network environment 101 may then perform statistical analysis on the received photos and/or videos to determine a common set of features associated with the logo(s). In some aspects, the determined features (or rules) may form an artificial neural network spanning multiple layers of abstraction. The network environment 101 may provide the set of rules (e.g., as the neural network models 102) to the user device 110 for inferencing.

The user device 110 may be any end-user or edge device. The user device 110 may interact with a user, for example, by receiving user inputs and/or outputting content to the user. In some aspects, the user device 110 may be any device capable of providing a customizable user experience (such as a personalized user interface) based on the preferences, activity, or habits of a given user. In some other aspects, the user device 110 may be any device capable of capturing, storing, and/or playing back media content. Example user devices may include, but are not limited to, set-top boxes (STBs), computers, mobile phones, tablets, televisions (TVs) and the like.

The user device 110 may include a neural network application 112, a content memory 114, and a user interface 116. The content memory 114 may store or buffer media content (e.g., thermal images, optical images, videos, audio, and the like) for playback and/or display on the user device 110 or a display device (not shown) coupled to the user device 110. In some aspects, at least some of the media content displayed by the user device 110 may correspond to premium media content 122 received (e.g., streamed) from one or more content delivery networks (CDNs) 120. For example, the premium media content 122 may include television shows, movies, and/or media content created by a third-party content creator or provider (e.g., television network, production studio, streaming service, and the like). In some implementations, the user device 110 may store or buffer the premium media content 122 in the content memory 114 for playback. For example, the content memory 114 may operate as a decoded video frame buffer that stores or buffers the (decoded) full-frame pixel data associated with the premium media content 122 to be rendered or displayed by the user device 110.

The neural network application 112 may be configured to generate one or more inferences about media content stored in the content memory 114. For example, in some aspects, the neural network application 112 may analyze the media content to infer or identify objects of interest (e.g., faces, logos, destinations, and the like) contained therein. In some embodiments, the neural network application 112 may generate the inferences based on the neural network models 102 received from the network environment 101. For example, during the inferencing phase, the machine learning system may apply the neural network models 102 to new media content stored in the content memory 114 (e.g., by traversing the artificial neurons in the artificial neural network) to infer information about the new media content (e.g., whether the media content includes one or more known logos).

Aspects of the present disclosure recognize that it may be undesirable (if not impossible) to send certain media content to the network environment 101, for example, to further refine the neural network models 102 and/or generate additional neural network models based on the media content stored on the user device 110. For example, content providers and/or creators may restrict the sharing or distribution of premium media content 122 (e.g., under “premium content protection” or Digital Rights Management (DRM) laws and regulations). Furthermore, users may not wish to have their personal information sent to the cloud, where it may be accessible to others. Thus, the embodiments described herein may be used to perform machine learning on media content in a manner that protects user privacy and the rights of content providers.

In some embodiments, the user device 110 may selectively send filtered feedback data 104 back to the network environment. In some aspects, the filtered feedback data 104 may include limited information about the inferences generated from the media content stored or buffered in the content memory 114. Specifically, the limited information may be selected or filtered such that it does not violate the privacy rights of the user of the user device 110 and/or the owner of the content. For example, the filtered feedback data 104 may not contain any pixel data or other information that can be used to reconstruct the original media content (e.g., images and/or videos) stored in the content memory 114. Furthermore, the filtered feedback data 104 may not reveal any personal identifying information about the user of the user device 110 (e.g., name, age, gender, location, and the like) or any information that can be used to derive such personal identifying information.

In some embodiments, the neural network application 112 may use the content stored or buffered in the content memory 114 to perform additional training on the neural network models 102. For example, the neural network application 112 may refine the neural network models 102 and/or generate new neural network models based on the media content stored or buffered in the content memory 114. In some aspects, the neural network application 112 may provide the updated neural network models to the network environment 101 (e.g., as filtered feedback data 104) to further refine the deep learning architecture. In this manner, the network environment 101 may further refine its neural network models 102 based on the media content stored on the user device 110 (e.g., and media content stored on various other user devices) without receiving or having access to the raw data corresponding to the actual media content.

Some media content (such as the premium media content 122) may be stored in a secure repository on the user device 110 (e.g., in a trusted environment). The secure repository may be virtually and/or physically partitioned from the rest of the user device 110 such that only applications and/or hardware residing within the trusted environment may have access to the data stored in the secure repository. In some aspects, the secure repository may be formed at least in part within the content memory 114. Thus, the premium media content 122 (and other protected content) may be stored within the secure repository of the content memory 114. Any hardware and/or applications operating outside the trusted environment (e.g., in a rich environment) may be restricted from accessing the data stored in the secure repository, whereas hardware and/or applications within the trusted environment may have very limited (if any) communication with the outside world.

To communicate with the outside world (e.g., with the network environment 101), some neural network applications may operate in the rich environment rather than the trusted environment. However, neural network applications operating in the rich environment may not have access to protected media content (such as the premium media content 122 or other media content protected under DRM, copyright, privacy laws, and the like), and may therefore be unable to perform machine learning (or deep learning) on such content.

In some embodiments, the neural network application 112 may reside, at least in part, within a trusted environment of the user device 110. Placing the neural network application 112 within the trusted environment enables the neural network application 112 to perform machine learning on protected media content (such as the premium media content 122) that would otherwise be inaccessible to neural network applications operating in the rich environment. For example, the neural network application 112 may access full-frame pixel data that can be used to render or display various television shows and/or movies that the user watches on the user device 110. As a result, the neural network application 112 may generate inferences about the interests and/or viewing habits of the user of the user device 110 based on the television shows and/or movies that the user watches. In some embodiments, the neural network application 112 (or another application executing on the mobile device 110) may further provide recommendations and/or additional content to the user based on the inferences about the user's viewing habits.

The user interface 116 may provide an interface or feature through which the user can operate, interact with, or otherwise use the device 110 or an electronic system (not shown for simplicity) coupled to the user device 110. In some aspects, the user interface 116 may include one or more input sources for receiving user inputs. Example input sources may include, but are not limited to, cameras, microphones, buttons, keyboards, mice, touchpads, fingerprint scanners, photosensors, accelerometers, gyroscopes, and the like. In some other aspects, the user interface 116 may include one or more output sources for outputting content to the user. Example output sources may include, but are not limited to, speakers, displays, lights, and the like. In some embodiments, the user interface 116 may display, render, or otherwise manifest content or information on the user device 110 based, at least in part, on the inferences generated by the neural network application 112.

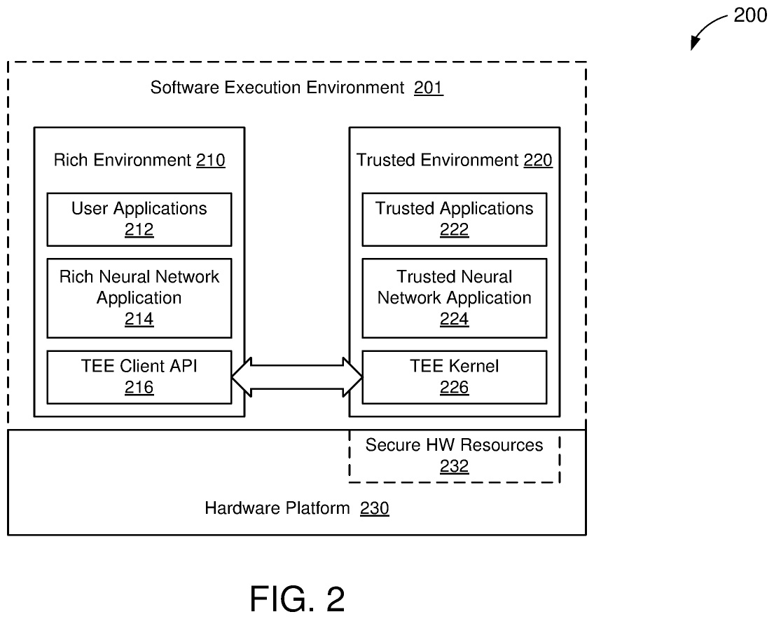

FIG. 2 shows a block diagram of a user device 200, in accordance with some embodiments. The user device 200 may be one embodiment of the user device 110 of FIG. 1. The user device 200 includes a hardware platform 230 and a software execution environment 201. The hardware platform 230 may include any hardware (e.g., processors, memory, communication interfaces, and the like) of the user device 200. The software execution environment 201 includes any software or instructions (e.g., kernels, operating systems, applications, and the like) executing on the hardware platform 230.

In some embodiments, the software execution environment 201 may be partitioned into a rich environment 210 and a trusted environment 220. The rich environment 210 may include one or more user applications 212, a rich neural network application 214, and a trusted execution environment (TEE) client application programming interface (API) 216. The trusted environment 220 may include one or more trusted applications 222, a trusted neural network application 224, and a TEE kernel 226. As described above, the trusted environment 220 may be physically or virtually partitioned (e.g., separated or walled off) from the rich environment 210. More specifically, only software or instructions executing in the trusted environment 220 may have access to secure hardware (HW) resources 232 residing on the hardware platform 230. Communications between the rich environment 210 and the trusted environment 220 are made possible only through the TEE client API 216. In this manner, the TEE client API 216 may ensure that the secure hardware resources 232 are inaccessible to any software or instructions executing in the rich environment 210.

In some embodiments, the secure hardware resources 232 may include a secure repository or memory (such as the content memory 114 of FIG. 1 or at least a portion thereof) for storing protected data. For example, in some aspects, the protected data may include premium content (e.g., television shows, movies, and the like) or other media content that may be protected under DRM, copyright, or other laws and/or regulations. In some other aspects, the protected data may include biometric signatures (e.g., images of the user's face, fingerprints, retinal scans, recordings of the user's voice, and the like) or other media that may be used for authentication purposes. Due to the secrecy and/or sensitivity of the protected data, the secure hardware resources 232 may be inaccessible to software and/or hardware outside of the trusted environment 220. Moreover, applications within the trusted environment 220 (such as the trusted applications 222 and the trusted neural network application 224) may be restricted from communicating information associated with the protected data to the rich environment 210.

In some embodiments, the user device 200 may perform machine learning on data stored on the hardware platform 230. In some aspects, the user device 200 may receive one or more neural network models from a network environment (such as the network environment 101 of FIG. 1) that may be used to generate inferences about the data stored on the hardware platform 230. In some other aspects, the user device 200 (e.g., the rich neural network application 214 and/or the trusted neural network application 224) may learn or generate at least some of the neural network models locally based on the data stored on the hardware platform 230 (e.g., as described above with respect to FIG. 1).

The rich neural network application 214 may apply the neural network models to unprotected data stored on the hardware platform 230 (e.g., in the rich environment 210). However, the rich neural network application 214 may not have access to the protected data stored in the secure hardware resources 232. In some embodiments, the trusted neural network application 224 may also receive the neural network models (e.g., via the TEE client API 216) and may apply the neural network models to the protected data stored in the secure hardware resources 232. In some aspects, the trusted neural network application 224 may also have access to unprotected data stored on the hardware platform 230 (e.g., in the rich environment 210).

Because the trusted neural network application 224 resides within the trust environment 220, the neural network application 224 may perform machine learning on the full-frame pixel data of the protected data stored in the secure hardware resources 232. Accordingly, the neural network application 224 may generate inferences about the protected data. Although the neural network application 224 may not send any raw data (e.g., pixel data) from the secure hardware resources 232 outside the trusted environment 220, the neural network application 224 may provide inferences about the raw data to the rich environment 210. As described in greater detail below, the inferences may be used to provide an enhanced user experience to the user of the user device 200. For example, because the inferences may be indicative of the user's interests, preferences and/or behavior, the user device 200 may use the inferences to output recommendations and/or additional content that may be relevant to the user.

In some aspects, the protected data may include premium media content, such as television shows or movies, that may be rendered or displayed on the user device 200 or a display device (not shown for simplicity) coupled to the user device 200. In some embodiments, the neural network application 224 may infer objects of interest (e.g., people, places, logos, and the like) from the premium content. For example, the neural network application 224 may identify logos or symbols associated with a content provider (e.g., a television broadcast network, movie production studio, and the like). The neural network application 224 may determine, based on the identified logos or symbols, that the user of the user device 200 has a preference for television shows broadcast on a particular television station or network. Accordingly, the neural network application 224 may recommend other shows to the user from the same television network.

In another example, the neural network application 224 may identify logos or symbols associated with product brands and/or advertisements. In some aspects, the neural network application 224 may determine, based on the identified logos or symbols, that the user of the user device 200 has a preference or interest in a particular brand or type of product. Accordingly, the neural network application 224 may present targeted advertisements to the user for the particular brand or type of product (or related brands and/or products). In some other aspects, the neural network application 224 may determine, based on the identified logos or symbols, which advertisements and/or product branding is most likely to have been viewed by the user of the user device 200. Accordingly, the neural network application 224 may provide attribution to the television network that broadcasted the media content for the advertisement or product placement.

In some other aspects, the protected data may include biometric data, such as faces, fingerprints, or voice recordings, that may be used to authenticate a user of the user device 200. In some embodiments, the neural network application 224 may generate one or more neural network models for the user based on the biometric data. The neural network application 224 may use the neural network models to infer the identity of the user from images and/or video subsequently captured via a camera or other image capture device residing on or coupled to the user device 200. In some aspects, the neural network application 224 may further display or recommend content to the user based on the user's identity. For example, the neural network application 224 may display television shows and/or movies that match the known interests of the user.

In some embodiments, other applications executing on the user device 200 (such as the user applications 212) may also leverage the inferences generated by the trusted neural network application 224 to enhance their user experience. For example, some applications may be configured to detect and respond to voice inputs. Once an object of interest has been detected by the trusted neural network application 224, a user may verbally instruct the user device 200 to retrieve additional information about the detected object (e.g., without any physical interaction with the user device 200). Furthermore, many voice-based applications use automatic speech recognition (ASR) to detect and respond to specific speech patterns. For example, the ASR application may look up specific phrases in one or more dictionaries or libraries to determine how to process or respond to voice inputs. Once an object of interest has been detected by the trusted neural network application 224, the user device 200 may retrieve relevant ASR dictionaries (e.g., related to the detect object) in preparation for responding to the user's voice input.

In some embodiments, the trusted neural network application 224 may generate additional neural network models, or refine existing neural network models, based on the data stored on the secure hardware resources 232. In some aspects, the rich neural network application 214 may receive the updated neural network models and/or filtered feedback data (e.g., from the trusted neural network application 224) via the TEE client API 216. The rich neural network application 214 may further transmit the updated neural network models and/or filtered feedback data to a cloud or network environment (such as the network environment 101 of FIG. 1). In this manner, the network environment may further refine the neural network models based on the data stored on the media device 200 (e.g., and content from various other content sources) without receiving or having access to the raw data stored in the secure hardware resources 232 of the media device 200.

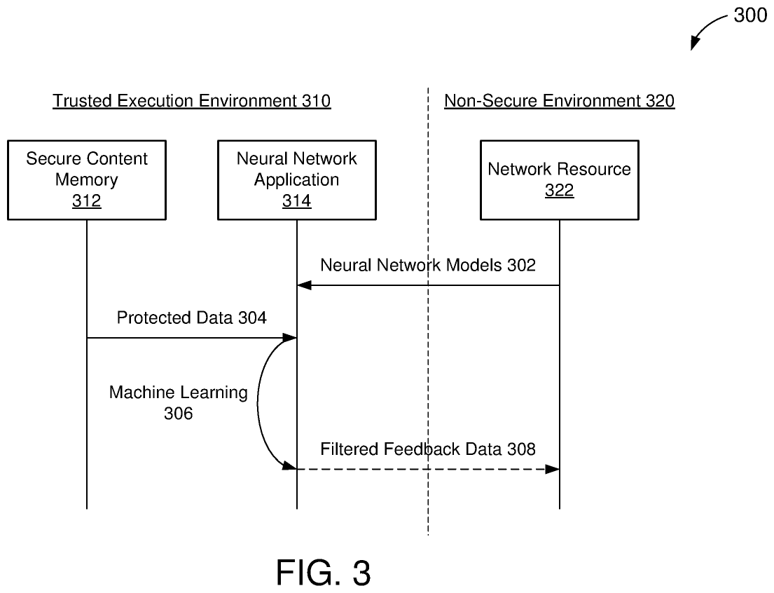

FIG. 3 shows a sequence diagram depicting an example process 300 for performing machine learning on protected data, in accordance with some embodiments. With reference for example to FIG. 1, the process 300 may be performed by the machine learning system 100 to generate and/or apply neural network models on data stored in a secure repository (e.g., in a trusted environment). In the embodiment of FIG. 3, the process 300 is carried out between a secure content memory 312, a neural network application 314, and a network resource 322. The secure content memory 312 and the neural network application 314 reside within a trusted execution environment 310 of a user device (such as the trusted environment 220 of FIG. 2), whereas the network resource 322 operates in a non-secure environment 320 (e.g., the outside world).

The network resource 322 may be configured to generate one or more neural network models 302 through machine learning (e.g., deep learning). In some aspects, the network resource 322 may be a cloud computing platform that may receive raw data from a plurality of content sources. The network resource 322 may be trained to recognize a set of rules (e.g., certain objects, features, a quality of service, and/or other detectable attributes) associated with the raw data. During the training phase, the network resource 322 may receive a large volume of raw data from one or more content sources communicatively coupled to the network resource 322. The network resource 322 may also receive an indication of one or more rules associated with the raw data (e.g., in the form of user input from a user or operator reviewing the media and/or data or metadata provided with the media). The network resource 322 may then perform statistical analysis on the raw data to determine a common set of attributes associated with the rules. In some aspects, the determined attributes (or rules) may form an artificial neural network spanning multiple layers of abstraction. The network resource 322 may provide the set of rules (e.g., as the neural network models 302) to the neural network application 314 for inferencing.

The neural network application 314 may receive the neural network models 302 (e.g., via a TEE client API provided on the user device) from the network resource 322 and may generate one or more inferences about data stored in the secure content memory 312 using the neural network models 302. The secure content memory 312 may store protected data (e.g., premium media content, biometric data, and the like) that may be displayed or rendered on the user device or a corresponding display device. More specifically, the protected data may be inaccessible to hardware and/or applications outside the trusted execution environment 310. However, because the neural network application 314 resides within the trusted execution environment 310, the neural network application 314 may have full access to the raw data stored in the secure content memory 312 (including full-frame pixel data for images and/or videos to be displayed on the user device).

The neural network application 314 may receive protected data 304 from the secure content memory 312. In some aspects, the protected data 304 may correspond to media content that is being streamed our played back by the user device. For example, the protected data 304 may include images and/or video that the user of the user device is currently viewing. In some other aspects, the protected data 304 may include biometric data that was stored in the secure content memory 312 during a prior enrollment or authentication process.

In some embodiments, the neural network application 314 may perform machine learning 306 on the protected data 304. In some aspects, the neural network application 314 may generate inferences about the protected data 304 based on one or more neural network models (such as the neural network models 302 received from the network resource 322). In some other aspects, the neural network application 314 may generate new neural network models (or rules) based on the protected data 304. Still further, in some aspects, the neural network application 314 may use the protected data 304 to update one or more existing neural network models (such as the neural network models 302 received from the network resource 322).

In some embodiments, the neural network application 314 may provide filtered feedback data 308 to the network resource 322 based, at least in part, on the machine learning 306 (e.g., as described above with respect to FIG. 2). In some aspects, the filtered feedback data 308 may include limited information about the inferences generated from the protected data 304. Specifically, the limited information may be filtered such that it does not violate the privacy rights of the user of the user device and/or the owner of the content. For example, the filtered feedback data 308 may not contain any raw data (e.g., pixel data) or other information that can be used to reconstruct the original data 304. Furthermore, the filtered feedback data 308 may not reveal any personal identifying information about the user of the user device (e.g., name, age, gender, location, and the like) or any information that can be used to derive such personal identifying information. In some other aspects, the filtered feedback data 308 may include the new or updated neural network models generated by the neural network application 314. In this manner, the network resource 322 may further refine its neural network models 302 without receiving or having access to the protected data 304.

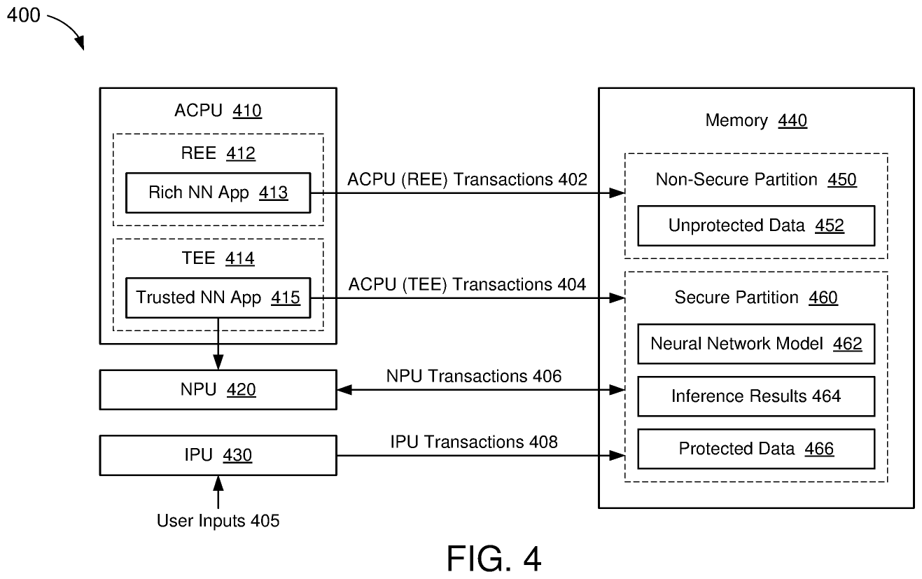

FIG. 4 shows a block diagram of a processing system 400, in accordance with some embodiments. The processing system 400 may be one embodiment of the user device 110 of FIG. 1 and/or user device 200 of FIG. 2. The processing system 400 includes an applications processing unit (ACPU) 410, a neural network processing unit (NPU) 420, an input processing unit (IPU) 430, and a memory apparatus 440.

The ACPU 410 may include one or more general-purpose processors configured to execute one or more applications and/or operating systems. The ACPU 410 may include a rich execution environment (REE) 412 and a trusted execution environment (TEE) 414. The REE 412 and TEE 414 may coincide with the rich environment 210 and the trusted environment 220, respectively, of the software execution environment 201. In the embodiment of FIG. 4, the ACPU 410 may execute a rich neural network (NN) application 413 in the REE 412 and may execute a trusted neural network (NN) application 415 in the TEE 414. In some implementations, the ACPU 410 is configurable to operate in a secure state and a non-secure state. For example, the ACPU 410 may operate in the secure state when executing applications and/or processes from the TEE 414 and may operate in the non-secure state when executing applications and/or processes from the REE 412.

The NPU 420 may include one or more processors that are configured to accelerate neural network inferencing. For example, the hardware architecture of the NPU 420 may be specifically designed to traverse neural networks more quickly and/or efficiently than a general-purpose processor, such as the ACPU 410. In some implementations, the ACPU 410 may call on the NPU 420, at least in part, to execute the rich neural network application 413 or the trusted neural network application 415. Thus, in some embodiments, the NPU 420 may also be configured to operate in a secure state and/or a non-secure state. When operating in the secure state, the NPU 420 may communicate with, and have access to, software and/or hardware resources residing in the trusted environment (such as the secure HW resources 232).

The IPU 430 may include hardware resources configured to process user inputs 405 (e.g., by filtering, analyzing, encoding, and the like) to be stored or otherwise used by the processing system 400. The user inputs 405 may include text-based inputs, selection-based inputs, and/or biometric inputs provided by a user. The user inputs 405 may be received and/or detected by one or more input devices (not shown for simplicity). Example input devices may include, but are not limited to, keyboards, mice, joysticks, cameras, capacitive sensors, touchpads, fingerprint sensors, microphones, and the like. In some implementations, the ACPU 410 may configure the IPU 430 to process user inputs 405 in connection with a trusted neural network application. Thus, the IPU 430 may also be configured to operate in a secure state. When operating in the secure state, the IPU 430 may communicate with, and have access to, software and/or hardware resources residing in the trusted environment (such as the secure HW resources 232).

The ACPU 410 may initiate non-secure memory access transactions 402 from the REE 412 and secure memory access transactions 404 from the TEE 414. The NPU 420 and IPU 430 may execute NPU transactions 406 and IPU transactions 408, respectively, with the memory apparatus 440. For example, each of the transactions 402-408 may comprise a read transaction (e.g., to read data from the memory apparatus 440) or a write transaction (e.g., to write data to the memory apparatus 440). The initiator of a transaction may be referred to as a “master” and the recipient of the transaction may be referred to as a “slave.” Thus, for purposes of discussion, the ACPU 410, NPU 420, and IPU 430 may generally be referred to herein as a plurality of masters. Although the processing system 400 is shown to include 3 masters 410-430, in some embodiments the processing system 400 may include fewer or more masters than those depicted in FIG. 4.

The memory apparatus 440 includes a non-secure partition 450 and a secure partition 460. The secure partition 460 and the non-secure partition 450 may be physically and/or virtually separate from one another. In some implementations, the memory partitions 450 and 460 may each comprise a different address space of a shared memory device (e.g., DRAM). In some other implementations, the memory partitions 450 and 460 may be implemented on separate memory devices. The non-secure partition 450 permanently resides in the rich environment and may therefore be configured to store any data that needs to be accessible by the REE 412 and other software and/or hardware resources operating form the rich environment. In contrast, the secure partition 460 permanently resides in the trusted environment and may therefore be configured to store data to be accessible only by the TEE 414 and other software and/or hardware resources operating from the trusted environment or in a secure state (such as the NPU 420 and/or IPU 430).

In the embodiment of FIG. 4, the non-secure partition 450 stores unprotected data 452 and the secure partition 460 stores neural network models 462, inference results 464, and protected data 466. In some implementations, the memory apparatus 440 may filter the memory transactions 402-408 based, at least in part, on the security state of the master initiating the transaction. More specifically, the memory apparatus 440 may ensure that software and/or hardware operating in the rich environment can access the non-secure partition 450 but not the secure partition 460. For example, the memory apparatus 440 may allow non-secure ACPU transactions 402 to access the unprotected data 452 but deny any non-secure ACPU transactions 402 from accessing the neural network models 462, the inference results 464, or the protected data 466.

The memory apparatus 440 may also ensure that software and/or hardware operating in the secure environment can access the secure partition 460. For example, the memory apparatus 440 may allow IPU transactions 408 to write protected data 466 (e.g., user data, premium media content, and the like) to the secure partition 460 when the IPU 430 initiates the transactions 408 from the secure state. The memory apparatus 440 may also allow NPU transactions 406 to read neural network models 462 and/or protected data 466 from the secure partition 460 and write inference results 464 to the secure partition 460 when the NPU 420 initiates the transactions 406 from the secure state. Still further, the memory apparatus 440 may allow secure ACPU transactions 404 to read inference results 464 from the secure partition.

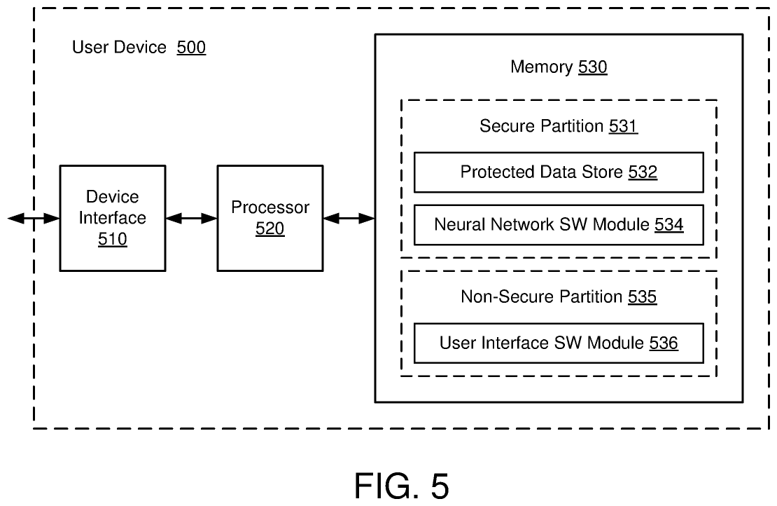

FIG. 5 shows another block diagram of a user device 500, in accordance with some embodiments. The user device 500 may be one embodiment of the user device 110 of FIG. 1 and/or user device 200 of FIG. 2. The user device 500 includes a device interface 510, a processor 520, and a memory 530.

The device interface 510 may be used to communicate with one or more input sources and/or output sources coupled to the user device 500. Example input sources may include, but are not limited to, cameras, microphones, buttons, keyboards, mice, touchpads, fingerprint scanners, photosensors, accelerometers, gyroscopes, and the like. For example, the sensor interface 510 may transmit signals to, and receive signals from, the input sources to receive user inputs from a user of the device 500. Example output sources may include, but are not limited to, speakers, displays, lights, and the like. For example, the sensor interface 510 may transmit signals to, and receive signals from, the output sources to output information and/or media content to the user of the device 500.

The memory 530 may include a secure partition 531 and a non-secure partition 535. The secure partition 531 may include a protected data store 532 configured to store protected data such as, for example, user data, premium media content, and the like. The secure partition 531 may also include a non-transitory computer-readable medium (e.g., one or more nonvolatile memory elements, such as EPROM, EEPROM, Flash memory, a hard drive, etc.) that may store a neural network software (SW) module 534 to generate inferences about protected data stored in the protected data store 532. Similarly, the non-secure partition 535 may include a non-transitory computer-readable medium that may store a user interface SW module 536 to output information and/or media content to the user based, at least in part, on the inferences about the protected data.

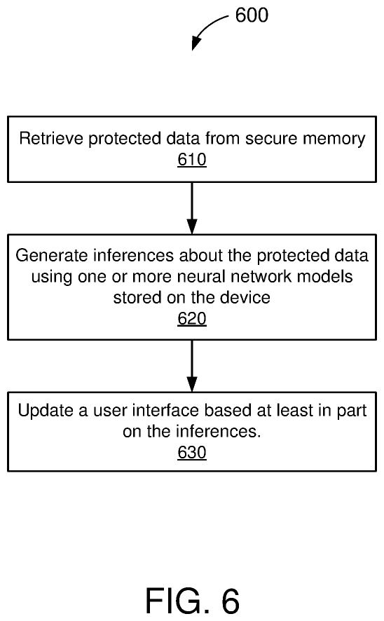

Each software module includes instructions that, when executed by the processor 520, cause the user device 500 to perform the corresponding functions. The non-transitory computer-readable medium of memory 530 thus includes instructions for performing all or a portion of the operations described below with respect to FIGS. 6-9. The processor 520 may be any suitable one or more processors capable of executing scripts or instructions of one or more software programs stored in the user device 500. For example, the processor 520 may execute the neural network SW module 534 to generate inferences about protected data stored in the protected data store 532. The processor 520 may also execute the user interface SW module 536 to output information and/or media content to the user based, at least in part, on the inferences about the protected data.

FIG. 6 is an illustrative flowchart depicting an operation 600 for inferencing by a user device, in accordance with some embodiments. With reference for example to FIG. 1, the operation 600 may be performed by a user device 110 having a secure memory or data repository.

The user device 110 may retrieve protected data from the secure memory (610). Example protected data may include, but is not limited to, premium media content, user data, and the like. In some implementations, the secure memory may correspond to a secure partition of a memory apparatus (such as the secure partition 460 of FIG. 4). More specifically, data stored in the secure partition may be inaccessible to hardware and/or applications executing in a rich environment of the user device 110. With reference for example to FIG. 4, the protected data 466 stored in the secure partition 460 may be inaccessible to applications executing from the REE 412 of the ACPU 410 (such as the rich neural network application 413). Thus, in some embodiments, the trusted neural network application 415 may retrieve the protected data 466 from the secure partition 460 of the memory apparatus 440.

The user device 110 may generate inferences about the protected data using one or more neural network models stored on the device (620). In some embodiments, the neural network models may also be stored in the secure memory. With reference for example to FIG. 4, the ACPU 410, in executing the trusted neural network application 415, may perform inferencing on the protected data 466 using the neural network models 462 stored in the secure partition 460. In some other aspects, the ACPU 410, in executing the trusted neural network application 415, may instruct the NPU 420 to perform inferencing on the protected data 466 using the neural network models 462. The inferences may identify objects of interest in protected the protected data. Example objects of interest may include, but are not limited to, logos, symbols, toys, and/or biometric features of one or more users of the user device 110.

The user device 110 may then update a user interface based at least in part on the inferences (630). For example, the inferences may be indicative of the user's interests, preferences and/or behavior. Thus, in some embodiments, the inferences may be used to provide recommendations and/or additional content via the user interface (e.g., to enhance or augment the user experience). In some aspects, the user device 110 may recommend shows to the user from a particular content source or television network. In some other aspects, the user device 110 may provide attribution, for a particular advertisement, to the television network or content source that broadcasted or streamed the media content which included the advertisement. Still further, in some aspects, the user device 110 may display television shows and/or movies that match the interests of a known user.

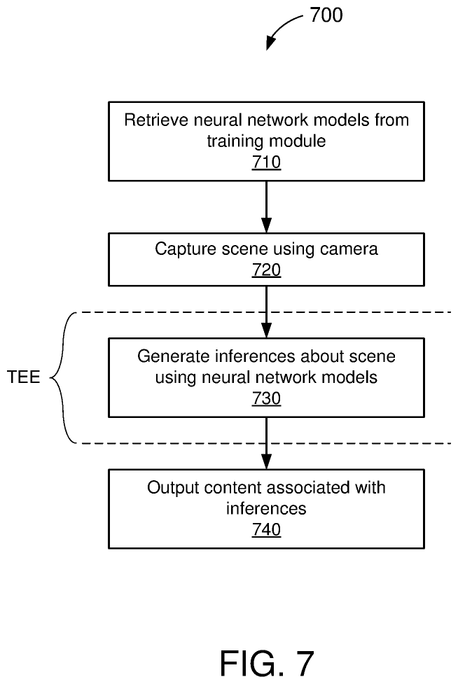

FIG. 7 is an illustrative flowchart depicting an example image capture operation 700, in accordance with some embodiments. With reference for example to FIG. 2, the operation 700 may be performed by the user device 200 to provide an augmented reality (AR) interface for camera-based applications.

The user device 200 may retrieve one or more neural network models from a training module (710). In some aspects, the training module may be located on a cloud or network environment (e.g., the network environment 101 of FIG. 1) external to the user device 200. In some other aspects, the training module may reside locally on the user device 200 (e.g., the rich neural network application 214 or the trusted neural network application 224). Thus, the neural network models can be trained and/or re-trained (e.g., to detect new objects) using only the data or information residing locally on the user device 200. In some embodiments, the neural network models may correspond to a set of rules describing certain objects of interest (e.g., dolls, action figures, or other toys that may have interactive features or aspects when presented in an AR environment, such as a game) that are detectable by the AR interface.

The user device 200 may further capture a scene using a camera (720). For example, the user applications 212 may include a camera-based application that can interface with a camera or other image capture device residing on, or coupled to, the user device 200. In some embodiments, the scene may include one or more users of the user device 200. Furthermore, the user application 212 may render or display the captured scene on a display of the user device 200 and/or a display device coupled to the user device 200.

The user device 200 may generate inferences about the scene using the one or more neural network models (730). For example, the neural network application 224 may detect and/or identify objects of interest in the scene based on the set of rules associated with the neural network models. In some aspects, the identified objects may correspond to toys (such as dolls, action figures, and the like, that may have applications in an interactive environment, such as an AR game) or other interactive objects that may be interfaced through the camera-based application (e.g., the user application 212). In some embodiments, the inferencing may be performed in a trusted execution environment (TEE). As described above, the trusted execution environment may allow only limited information to be shared with the outside world. Thus, by generating the inferences within the trusted execution environment, the trusted neural network application 224 may ensure that the user's privacy and/or personal information is protected.

The user device 200 may further output content associated with the inferences (740). For example, the user application 212 may receive the inferences from the neural network application 224 and may provide the user with supplemental content associated with the objects inferenced in the scene. In some aspects, the user application 212 may display a description of the object (e.g., as an AR overlay on top of the scene). In some other aspects, the user application 212 may playback audio associated with the object (such as the name of the object) via speakers on or coupled to the user device 200. For example, the audio may be played back in a number of different languages. Still further, in some aspects, the user application 212 may provide the user with an option to view images and/or videos (such as a movie or television show) associated with the identified object.

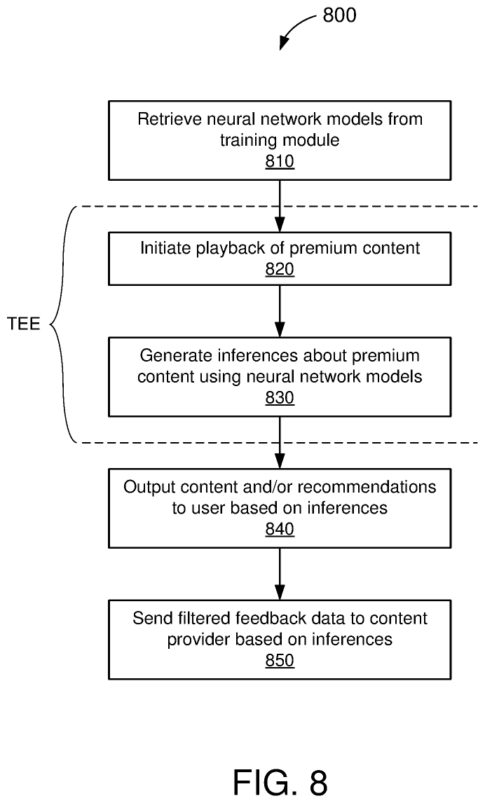

FIG. 8 is an illustrative flowchart depicting an example media playback operation 800, in accordance with some embodiments. With reference for example to FIG. 2, the operation 800 may be performed by the user device 200 to provide a dynamic video interface for the playback of media content based on a user's interests or preferences.

The user device 200 may retrieve one or more neural network models from a training module (810). In some aspects, the training module may be located on a cloud or network environment (e.g., the network environment 101 of FIG. 1) external to the user device 200. In some other aspects, the training module may reside locally on the user device 200 (e.g., the rich neural network application 214 or the trusted neural network application 224). In some embodiments, the neural network models may correspond to a set of rules describing certain objects of interest (e.g., logos, symbols, and other brand-identifying marks) that are detectable in media content displayed or played back by the user device 200.

The user device 200 may initiate playback of premium content (820). For example, the premium content may include any media content (such as television shows or movies) that are protected by DRM, copyright, trademark, and various other laws and/or regulations. In some aspects, the premium content may be received from (e.g., streamed or otherwise provided by) one or more content delivery networks (CDNs). As described above, such premium content may be stored or buffered in a secure repository (e.g., the secure hardware resources 232) residing within a trusted execution environment (TEE) of the user device 200. More specifically, the secure hardware resources 232 may be inaccessible to software and/or hardware outside of the trusted environment.

The user device 200 may generate inferences about the premium content using the one or more neural network models (830). For example, the neural network application 224 may detect and/or identify objects of interest in the premium content based on the set of rules associated with the neural network models. In some aspects, the identified objects may correspond to logos, symbols, and other brand-identifying marks that may indicate a production studio, television network, or advertiser involved with the premium content. As described above, the trusted execution environment may be inaccessible to the outside world. However, because the trusted neural network application 224 resides within the trusted execution environment, the trusted neural network application 224 may have access to the full frame-pixel data that is used to display or render the premium content on the user device 200. Accordingly, the neural network application 224 may generate the inferences about the premium content based on the actual pixel data stored or buffered in a decoded video frame buffer (e.g., to be rendered or displayed by the user device 200).

The user device 200 may further output content and/or recommendations based on the inferences (840). For example, the user applications 212 may include a video playback application that can stream or playback the premium content stored in the secure hardware resources 232. The user application 212 may receive the inferences from the neural network application 224 and may provide the user with supplemental content associated with the objects inferenced in the premium content. In some embodiments, the user application 212 may determine the user's preferences and/or interests based on the inferences (e.g., logos, symbols, and the like) received from the neural network application 224.

For example, in some aspects, the user application 212 may determine, based on the identified logos or symbols, that the user of the user device 200 has a preference for television shows broadcast on a particular television station or network. Accordingly, the user application 212 may recommend other shows to the user from the same television network or production studio. In some implementations, the owner or creator of the media content (e.g., which may be a broadcast television network or production studio) may be different than the content delivery network (CDN) that streams or transmits the media content to the user device 200 (e.g., which may be a streaming video-on-demand (VoD) or pay-per-view (PPV) service). Thus, in some aspects, the user application 212 may provide the user with an option to view additional content from a preferred content creator or owner (e.g., based on the inferences generated by the neural network application 224), where such additional content is available for streaming (or delivery) by the same CDN that streamed (or otherwise delivered) the premium content from which the inferences were made.

In some other aspects, the user application 212 may determine, based on the inferences (e.g., the identified logos or symbols), that the user of the user device 200 has a preference or interest in a particular brand or type of product. Accordingly, the user application 212 may present targeted advertisements to the user for the particular brand or type of product (or related brands and/or products). For example, the targeted advertisements may include an option to purchase the identified products.

Still further, in some embodiments, the user device 200 may send filtered feedback data to a content provider based on the inferences (850). For example, in some other aspects, the user application 212 may determine, based on the inferences, which advertisements and/or product branding is most likely to have been viewed by the user of the user device 200. Accordingly, the user application 212 may provide attribution to the television network that broadcasted the media content for the advertisement or product placement. For example, the user application 212 may provide analytics regarding the advertisement (such as the timing of advertisement, the network that displayed the advertisement, the location in which the advertisement was viewed, and the like) to the company that created the product and/or advertisement.

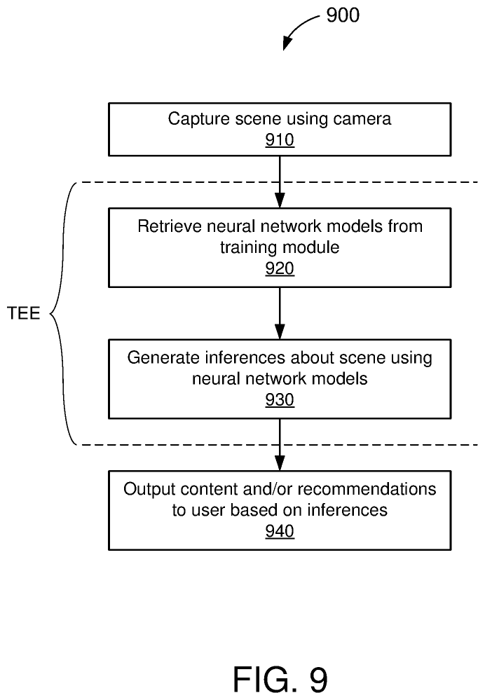

FIG. 9 is an illustrative flowchart depicting an example authentication operation 900, in accordance with some embodiments. With reference for example to FIG. 2, the operation 900 may be performed by the user device 200 to provide a dynamic video interface for the playback of media content based on a user classification.

The user device 200 may capture a scene using a camera (910). For example, the user applications 212 may include a camera-based application that can interface with a camera or other image or video capture device residing on, or coupled to, the user device 200. In some embodiments, the scene may include one or more users of the user device 200. In some aspects, the user application 212 may render or display the captured scene on a display of the user device 200 and/or a display device coupled to the user device 200.

The user device 200 may retrieve one or more neural network models from a training module (920). In some embodiments, the neural network models may correspond to a set of rules describing biometric indicators (e.g., facial features, voice patterns, fingerprints, and the like) that may be used to authenticate a user of the user device 200. The neural network models may be generated based on biometric data acquired during an enrollment process (e.g., when the user enrolls his or her biometric signature for detection by the user device 200). For enhanced security, and to protect the privacy of the user, the biometric data may be stored in a secure repository (e.g., the secure hardware resources 232) residing within a trusted execution environment (TEE) of the user device 200. Thus, in some embodiments, the training module (e.g., the trusted neural network application 224) may also reside within the trusted execution environment on the user device 200.

The user device 200 may generate inferences about the scene using the one or more neural network models (930). For example, the neural network application 224 may detect and/or identify objects of interest in the scene based on the set of rules associated with the neural network models. In some aspects, the identified objects may correspond to biometric features (such as a user's face) that may indicate the identity of the user(s) of the user device 200. For example, the neural network application 224 may classify one or more users of the user device 200 (e.g., the person or persons in the scene captured by the camera) based on the identified biometric features. As described above, the trusted execution environment may be inaccessible to the outside world. However, because the trusted neural network application 224 resides within the trusted execution environment, the neural network application 224 may have access to the biometric data (and neural network models) associated with each user. In some embodiments, the neural network application 224 may use the images or video captured of the scene to further train or re-train the neural network models (such as the last layer or last few layers of the neural network models) for the user.

The user device 200 may further output content and/or recommendations based on the inferences (940). For example, the user application 212 may receive the inferences from the neural network application 224 and may provide the user(s) with targeted recommendations for the user(s) of the user device 200. More specifically, the user application 212 may determine which recommendations to display through the user device 200 based, at least in part, on the classification of the one or more users of the user device 200. As described above with respect to FIG. 5, the user application 212 may have knowledge of the users' interests and/or preferences for media content. Thus, the user application 212 may provide the user(s) with an option to view images and/or videos (such as movies or television shows) that match the interests of one or more users the user device 200. In some aspects, the user application 212 may generate a custom user interface (e.g., program guide, launcher, and the like) that is curated for the interests or preferences of the one or more users. For example, the custom user interface (UI) may include only the types of media content that match the interests of the one or more users (e.g., sports, reality shows, dramas, and the like). In some aspects, the custom UI may be dynamically updated each time a new user is detected by the user device 200.

In some aspects, where multiple users are detected by the neural network application 224, the user application 212 may display recommendations for only one of the users. For example, if an adult is detected by the neural network application 224 with one or more children, the user application 212 may display recommendations that are suitable for children only (e.g., cartoons, educational programs, and other child-friendly content). In some other aspects, where multiple users are detected by the neural network application 224, the user application 212 may display recommendations for multiple users. For example, if a husband and wife are detected by the neural network application 224, the user application 212 may display recommendations for the husband as well as recommendations for the wife. Still further, in some aspects, the neural network application 224 may display recommendations for a group of users. For example, if a group of friends is detected by the neural network application 224, the user application 212 may display recommendations based on the common interests of the group (e.g., game shows, sports, and other shows or programming that the group as a whole is known to enjoy).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of inferencing by a user device, comprising:
retrieving protected data from a secure memory, wherein the secure memory is inaccessible to applications executing in a rich environment of the user device;
generating inferences about the protected data using one or more neural network models stored on the user device; and
updating a user interface of the user device based at least in part on the inferences.

2. The method of claim 1, wherein the one or more neural network models are stored in the secure memory.

3. The method of claim 1, wherein the inferences are generated, at least in part, by a neural network application executing in a trusted environment of the user device.

4. The method of claim 1, wherein the inferences are generated, at least in part, by a neural network processing unit (NPU).

5. The method of claim 1, wherein the protected data includes pixel data for premium media content to be displayed or played back via the user interface.

6. The method of claim 1, wherein the protected data includes user input data or personal information about a user of the device.

7. The method of claim 1, wherein the updating comprises:
outputting content or recommendations via the user interface based at least in part on the inferences.

8. The method of claim 1, further comprising:
transmitting filtered feedback data to an external network based at least in part on the inferences, wherein the filtered feedback data does not include any of the protected data stored in the secure memory.

9. The method of claim 1, further comprising:
updating the one or more neural network models based at least in part on the inferences.

10. The method of claim 7, further comprising:
sending the updated neural network models to an external network resource configured for training neural network models.

11. A user device comprising:
a user interface;
processing circuitry; and
a secure memory storing instructions that, when executed by the processing circuitry, causes the user device to:
retrieve protected data from the secure memory, wherein the secure memory is inaccessible to applications executing in a rich environment of the user device;
generate inferences about the protected data using one or more neural network models stored on the user device; and
update the user interface based at least in part on the inferences.

12. The user device of claim 11, wherein the one or more neural network models are stored in the secure memory.

13. The user device of claim 11, wherein the instructions are executed in a trusted environment of the user device.

14. The user device of claim 11, wherein the processing circuitry includes a neural network processing unit (NPU).

15. The user device of claim 11, wherein the protected data includes pixel data for premium media content to be displayed or played back via the user interface.

16. The user device of claim 11, wherein the protected data includes user input data or personal information about a user of the device.

17. The user device of claim 11, wherein execution of the instructions for updating the user interface causes the user device to:
output content or recommendations via the user interface based at least in part on the inferences.

18. The user device of claim 11, wherein execution of the instructions further causes the user device to:
update the one or more neural network models based at least in part on the inferences.

19. A user device comprising:
processing circuitry configured to operate in a secure state or a non-secure state; and
a memory having a secure partition and a non-secure partition, the secure partition storing instructions that, when executed by the processing circuitry while operating in the secure state, causes the user device to:
retrieve protected data from the secure partition, wherein the secure partition is inaccessible to the processing circuitry when operating in the non-secure state;
retrieve one or more neural network models from the secure partition; and
generate inferences about the protected data using the one or more neural network models.

20. The user device of claim 19, wherein the protected data includes pixel data for premium media content to be displayed or played back via the user interface.

21. The user device of claim 19, wherein the protected data includes user input data or personal information about a user of the device.

22. The user device of claim 19, wherein execution of the instructions further causes the user device to:
output content or recommendations based at least in part on the inferences.

23. The user device of claim 19, wherein the non-secure partition stores instructions that, when executed by the processing circuitry, further causes the user device to:
transmit filtered feedback data to an external network based at least in part on the inferences, wherein the filtered feedback data does not include any of the protected data stored in the secure memory.

24. The user device of claim 19, wherein execution of the instructions further causes the user device to:
update the one or more neural network models based at least in part on the inferences.

25. The user device of claim 24, wherein the non-secure partition stores instructions that, when executed by the processing circuitry, further causes the user device to:
transmit the updated neural network models to an external network resource configured for training neural network models.
